(19) United States
(12) Patent Application Publication
(10) Pub. No.: US 2017/0091483 A1
(43) Pub. Date: Mar. 30, 2017

(54) Method and Device for Protecting Address Book, and Communication System

(71) Applicant: ZTE Corporation, Shenzhen (CN)

(72) Inventor: Tao GU, Shenzhen (CN)

(21) Appl. No.: 15/127,879

(22) PCT Filed: Aug. 20, 2014
(86) PCT No.: PCT/CN2014/084857

§ 371 Date: Sep. 21, 2016

(30) Foreign Application Priority Data
Mar. 24, 2014 (CN) 201410112633.1

(51) Int. Cl. G06F 21/62; H04W 8/26; H04W 12/06; H04W 12/02; G06F 21/72

(52) U.S. Cl. CPC G06F 21/6245; H04W 12/02; G06F 21/72; H04W 12/06; H04W 8/26

(57) ABSTRACT

Provided are a method and device for protecting an address book and a communication system. The method comprises: when encrypting at least one contact in the address book, encryption processing is performed on contact number information of the contact and no encryption processing is performed on contact name information of the contact, such that, after encryption, the contact number information of the contact is hidden and the contact name information of the contact can be displayed normally. A user can find out a contact directly through the corresponding contact name information normally displayed, different from an existing encryption mechanism in which a user is required to login a verification password or passcode first every time acquiring the contact name information; the present disclosure is more convenient for a user to use and improves the satisfaction degree of user experience while ensuring encryption safety.

### TECHNICAL FIELD

The present disclosure relates to the field of communications, and in particular to a method and device for protecting an address book, and a communication system.

### BACKGROUND

The latest communication industry operation report released by the China's Ministry of Industry and Information Technology shows that mobile phone users all over the country have broken through 1 billion, 143.919 million of which is accounted for by 3G users. As the increase in mobile phone users, mobile phones are stolen or lost occasionally, and people expect that the information in the address book is not seen by other people, thus the privacy of personal address book is paid more and more attention. To realize the privacy of personal address book, at present, an address book encryption function is applied in some mobile phones. Through the address book encryption function, one or more contacts in the address book are isolated out, and encryption processing is performed on the contact names and corresponding phone numbers so that unauthorized person cannot see the relevant information of the contact. However, this type of mobile phones employing the privacy function is very inconvenient to communicate with an encrypted contact, a verification password or passcode being required to be logged in first, and, only after the verification is successful, the user can find the corresponding contact and then obtain the corresponding number to perform communication; thus user experience is reduced.

### SUMMARY

The technical problem to be solved by the embodiments of the present disclosure is to provide a method and device for protecting an address book and a communication system, so as to solve the problem of inconvenience caused by an existing address book encryption mechanism in which both contact name information and number information are all encrypted.

In order to solve the above technical problem, the embodiment of the present disclosure provides a method for protecting an address book, wherein a contact stored in the address book of a communication terminal at least comprises contact number information and contact name information, the method comprising: the communication terminal performing encryption processing on contact number information of at least one contact in the address book and displaying contact name information of the contact.

In an example embodiment of the present disclosure, the method further comprising: when the communication terminal judges that a current contact performing communication with the communication terminal is an encrypted contact, the communication terminal performing encryption processing, in a communication display interface and/or a communication record of the communication, on contact number information of the current contact.

In an example embodiment of the present disclosure, the communication terminal judging whether the current contact performing the communication with the communication terminal is the encrypted contact comprises: when the communication terminal serving as a called party receives a communication request initiated by a calling party, the communication terminal performing decryption processing on all encrypted contact number information in the address book to judge whether number information of the calling party is encrypted contact number information; when the communication terminal serving as a calling party initiates communication with a contact in the address book, the communication terminal judging whether contact number information corresponding to contact name information of the contact is encrypted.

In an example embodiment of the present disclosure, the method further comprising: the communication terminal storing a decryption login verification code set by a user; when the communication terminal receives a request for viewing contact number information of an encrypted contact in the address book, the communication terminal judging whether a decryption login verification code input by a user initiating the request is the same as the stored decryption login verification code; when a judgment result is that the decryption login verification code input by the user initiating the request is the same as the stored decryption login verification code, the communication terminal performing decryption processing on the contact number information of the contact.

In an example embodiment of the present disclosure, an encryption key adopted to perform encryption processing on the contact number information is generated based on a unique identification code of a Subscriber Identity Module, SIM, in the communication terminal and/or a unique identification code of the communication terminal.

In order to solve the above technical problem, the embodiment of the present disclosure provides a device for protecting an address book, comprising a first encryption component and a displaying component, wherein the first encryption component is configured to perform encryption processing on contact number information of at least one contact in the address book of a communication terminal, a contact stored in the address book of a communication terminal at least comprises contact number information and contact name information, and the displaying component is configured to display contact name information of the contact.

In an example embodiment of the present disclosure, the device further comprising a communication judgement component and a second encryption component, wherein the communication judgement component is configured to: when judging that a current contact performing communication with the communication terminal is an encrypted contact, notify the second encryption component to perform encryption processing, in a communication display interface and/or a communication record of the communication, on contact number information of the current contact.

In an example embodiment of the present disclosure, the device further comprising a login verification component and a decryption component, wherein the login verification component is configured to: store a decryption login verification code set by a user, and, when receiving a request for viewing contact number information of an encrypted contact in the address book, judge whether a decryption login verification code input by a user initiating the request is the same as the stored decryption login verification code; when a judgment result is that the decryption login verification code input by the user initiating the request is the same as the stored decryption login verification code, notify the decryption component to perform decryption processing on the contact number information of the contact.

In an example embodiment of the present disclosure, the device further comprising a private key generation component, configured to generate, based on a unique identification code of a Subscriber Identity Module, SIM, in the communication terminal and/or a unique identification code of the communication terminal, an encryption key for encrypting the contact number information.

In order to solve the above technical problem, the embodiment of the present disclosure provides a communication terminal, comprising a memory and a processor, wherein the memory is configured to store at least one program component and the processor is configured to call the at least one program component to execute following steps: performing encryption processing on contact number information of at least one contact in an address book of the communication terminal and displaying contact name information of the contact.

The embodiments of the present disclosure have benefits as follows:

in the method and device for protecting an address book and a communication system provided by the embodiments of the present disclosure, when encrypting at least one contact in the address book, encryption processing is performed on contact number information of the contact and no encryption processing is performed on contact name information of the contact, such that, after encryption, the contact number information of the contact is hidden and the contact name information of the contact can be displayed normally. In this way, a user can find out a contact directly through the corresponding contact name information normally displayed, different from an existing encryption mechanism in which a user is required to login a verification password or passcode first every time acquiring the contact name information; the present disclosure is more convenient for a user to use and improves the satisfaction degree of user experience while ensuring encryption safety.

### BRIEF DESCRIPTION OF THE DRAWINGS

FIG. 1 is a flowchart of a method for protecting an address book provided by the first embodiment of the present disclosure;

FIG. 2 is a flowchart of a process of initiating a communication request provided by the first embodiment of the present disclosure;

FIG. 3 is a flowchart of a process of receiving a communication request provided by the first embodiment of the present disclosure;

FIG. 4 is a flowchart of a process of viewing the contact number information provided by the first embodiment of the present disclosure;

FIG. 5 is a first structure diagram of a device for protecting an address book provided by the second embodiment of the present disclosure;

FIG. 6 is a second structure diagram of a device for protecting an address book provided by the second embodiment of the present disclosure; and

FIG. 7 is a structure diagram of a communication terminal provided by the second embodiment of the present disclosure.

### DETAILED DESCRIPTION OF THE EMBODIMENTS

The present disclosure is described below in further detail in combination with accompanying drawings and embodiments.

### Embodiment 1

In this embodiment, a contact stored in the address book of a communication terminal at least includes contact number information and contact name information, and may include other information of the stored contact as required. In the method for protecting an address book provided by this embodiment, when encrypting at least one contact in an address book, encryption processing is performed on contact number information of the contact to be encrypted and no encryption processing is performed on the contact name information of the contact, such that, after encryption, the contact number information of the contact is hidden and the contact name information of the contact can be displayed normally. In this way, a user can find out a contact directly through the corresponding contact name information normally displayed, different from an existing encryption mechanism in which a user is required to login a verification password or passcode first every time acquiring the contact name information; the present disclosure is more convenient for a user to use and improves the satisfaction degree of user experience while ensuring encryption safety. Of course, in this embodiment, before encrypting the contact in the address book, the method may also include a step of performing encryption/decryption login setting, in which the communication terminal may store a decryption login code required during decryption after encryption, wherein the decryption login code is set by a user so as to verify the identity of the user; in this step, the communication terminal may also generate an encryption key and/or decryption key for following encryption and decryption.

In this embodiment, specific encryption/decryption mechanism and algorithms may be selected as actually requirement; for example, a symmetric encryption mechanism may be employed to obtain an encryption key and a decryption key which are the same; an asymmetric encryption mechanism may be employed to obtain an encryption key and a decryption key which are different. The random generation algorithm for key is closely correlated to the selected encryption algorithm, for example, when a symmetric encryption algorithm Data Encryption Standard (DES) is employed, the obtained key is a 64-bit pseudorandom sequence; an algorithm may be selected to randomly generate a 64-bit enhanced key to encrypt contact numbers, and no further description is needed here.

In this embodiment, in order to further enhance the security of encryption, when generating an encryption key and/or decryption key, the encryption key and/or decryption key may be bound with the communication terminal and/or the SIM card in the communication terminal, that is to say, the encryption key and/or decryption key may be generated based on the unique identification code of the communication terminal and/or the unique identification code of the SIM card in the communication terminal (for example, the International Mobile Equipment Identity (IMEI) of the communication terminal, the International Mobile Subscriber Identification Number (IMSI) of the SIM card). In this way, when the communication terminal is lost, since the encrypted contact number information in the lost communication terminal has subjected to encryption processing, the contact number information cannot be queried without a correct verification login password; moreover, after the lost SIM card is reported of loss and replaced, the SIM card in the lost communication terminal cannot be used for call and short message connection, which further achieves the privacy of the address book.

The address book involved in this embodiment generally may be divided into two parts: one part is stored in the SIM card of the communication terminal, and the other part is stored in the local memory or Secure Digital (SD) Memory Card of the communication terminal. At present, a smart communication terminal have a large storage space, which does not limit an encryption algorithm; however, the SIM card has a limited space, in which the encryption of the contact number in the address book will be restricted; generally, for the record format in the address book, the minimum record format is of 14 bytes and the longest record format is not greater than 255 bytes, thus, encryption storage preferably should not exceed the maximum limit of one communication record.

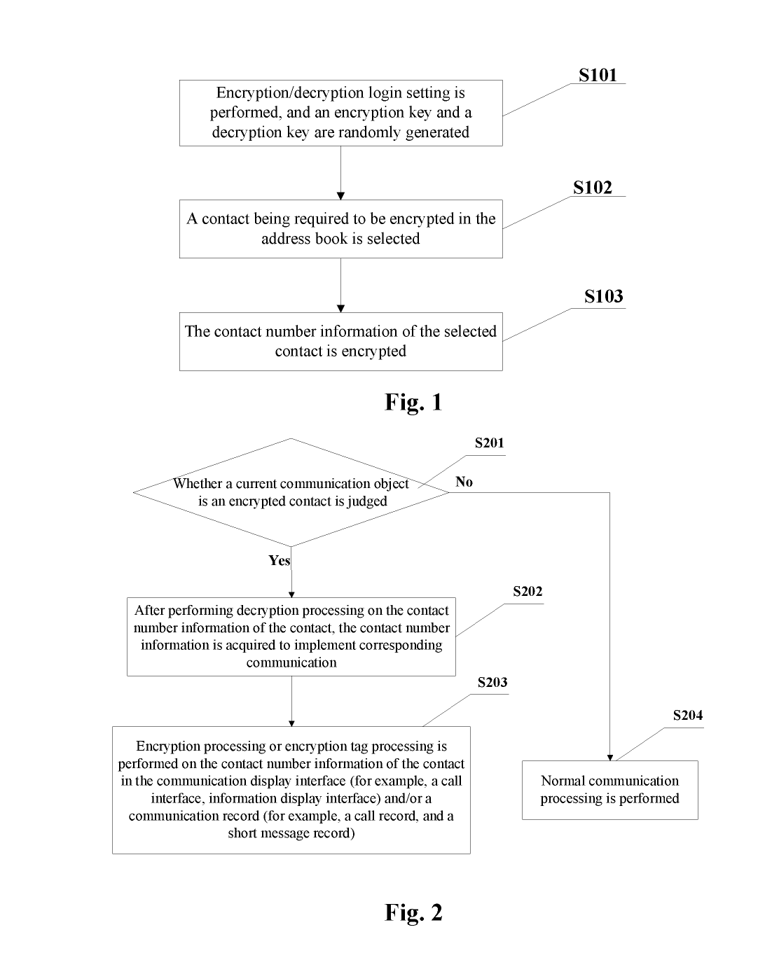

Please refer to FIG. 1, the method for protecting an address book provided by this embodiment includes the following steps:

S101: Encryption/decryption login setting is performed, and an encryption key and a decryption key are randomly generated.

S102: A contact required to be encrypted in the address book is selected.

S103: The contact number information of the selected contact is encrypted, wherein the contact number information includes at least one of followings: phone numbers, an email account, QQ numbers and the like; no encrypting processing is performed on the contact name information of the contact and the contact name information of the contact can be displayed normally.

After the contact number of a corresponding contact is encrypted through the above encryption steps, the current operation refers to initiating a communication request. For example, a communication operation such as short message communication and call communication is initiated to a contact in the address book. The contact is found through the name information of the contact and whether the contact number information corresponding to the contact name information has been encrypted is judged; when a judgment result is that the contact number information corresponding to the contact name information has been encrypted, the contact number information of the contact is automatically decrypted to obtain the contact number information of the contact so as to implement communication, and then the contact number information of the contact is shielded in the communication display interface (for example, a call interface, an information display interface) and/or a communication record (for example, a call record, a short message record) of the communication; specifically, a shielding operation may be realized through encrypting processing or encryption tags. When the record or the address book is viewed, merely the contact name information of the contact can be viewed, the contact number information cannot be viewed; the presented interface may display merely the contact name, not display the communication number. The specific communication process may refer to FIG. 2, including:

S201: Whether a current communication object is an encrypted contact is judged; when a judgment result is that the current communication object is not the encrypted contact, S204 is executed; otherwise, S202 is executed.

S202: after performing decryption processing on the contact number information of the contact using the decryption key generated in S101, the contact number information is obtained to implement corresponding communication.

S203: Encryption processing or encryption tag processing is performed, in a communication display interface (for example, a call interface, an information display interface) and/or a communication record (for example, a call record, a short message cords), on the contact number information of the contact. When the record or the address book is viewed, merely the contact name information of the contact can be viewed, the contact number information cannot be viewed; the presented interface may display merely the contact name, not display the communication number.

S204: Normal communication processing is performed, including normally implementing communication and storing communication records, etc.

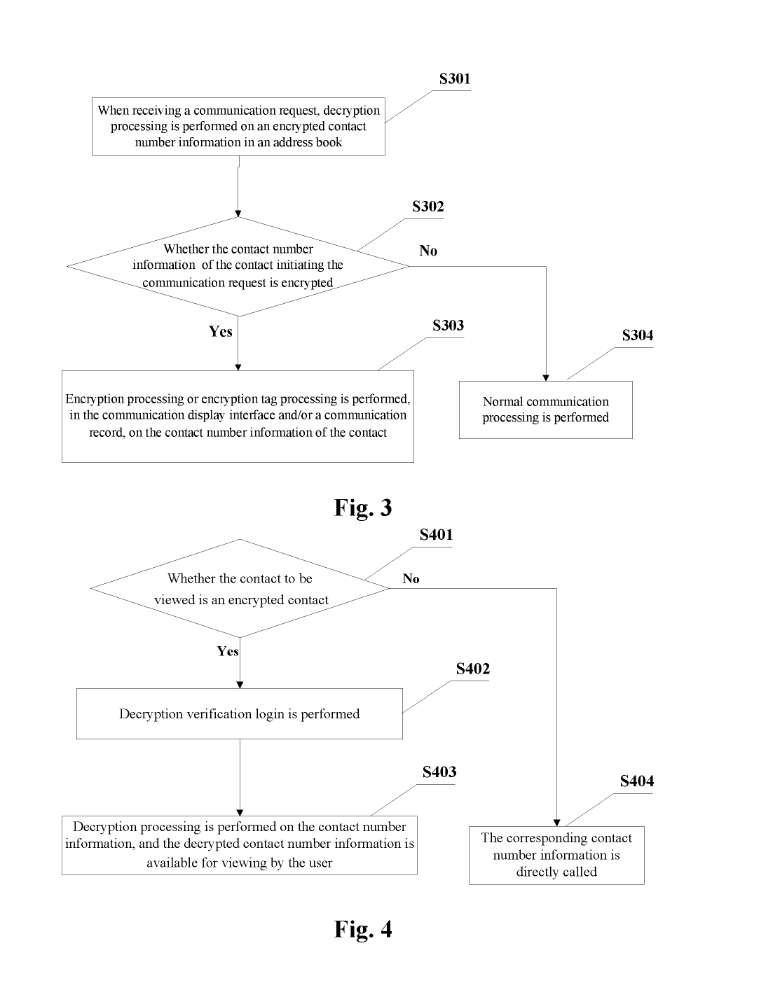

FIG. 2 is described by taking the communication terminal serving as a calling terminal initiating communication for example; when the communication terminal serves as a called terminal, when receiving a communication request, the process may refer to FIG. 3, including:

S301: when receiving a communication request, decryption processing is performed on the encrypted contact number information in the address book.

S302: whether the contact number information of the contact initiating the communication request is encrypted contact number information is judged; when a judgment result is that the contact number information of the contact initiating the communication request is the encrypted contact number information, S303 is executed; otherwise, S304 is executed.

S303: Encryption processing or encryption tag processing is performed on the contact number information of the contact in a communication display interface and/or a communication record of this communication. When the record or the address book is viewed, merely the contact name information of the contact can be viewed, the contact number information cannot be viewed; the presented interface may display merely the contact name, not display the communication number.

S304: Normal communication processing is performed, including normally implementing communication and storing the communication record, etc.

After encryption is performed according to the process shown in FIG. 1, when a user needs to view contact numbers, the process may refer to FIG. 4, including:

S401: Whether the contact to be viewed is an encrypted contact is judged; when the contact to be viewed is the encrypted contact, S402 is executed; otherwise, S404 is executed.

S402: Decryption verification login is performed; S403 is executed when the verification is passed; the process is directly ended when the verification is failed.

S403: Decryption processing is performed on the contact number information, and the decrypted contact number information is available for viewing by the user.

S404: The corresponding contact number information is directly called to present to the user.

Thus, in the method for protecting the address book provided by this embodiment, a login verification operation is not required, except for the operation of viewing an encrypted contact, thereby improving user experience. Meanwhile, when the communication terminal of a user is lost or stolen, after the SIM card is reported of loss and replaced, the lost SIM card cannot be used any more; further, since an encryption algorithm is selected and there is an binding operation in the encryption process, and different mobile phones adopt different encryption/decryption keys, the mobile phone employing the same encryption algorithm is incapable of decrypting correctly after the card is changed, thus the encrypted contact information in the SIM card and the address book of the mobile phone is protected.

### Embodiment 2

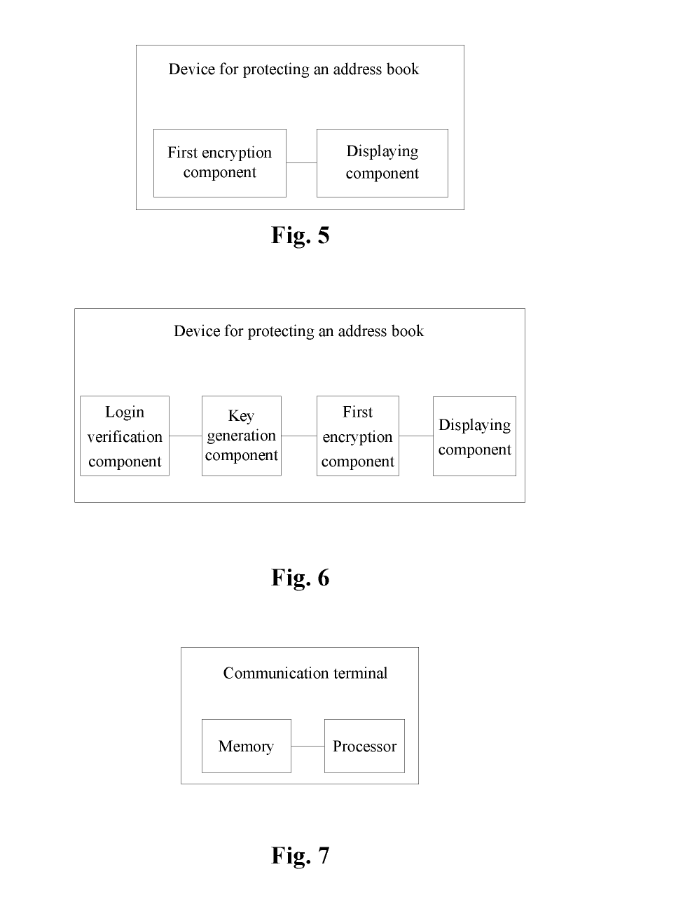

This embodiment provides a device for protecting an address book, which, by reference to FIG. 5, includes a first encryption component and a displaying component, wherein the first encryption component is configured to perform encryption processing on the contact number information of at least one contact in the address book, such that, after encryption, the contact number information of the contact is hidden; and the displaying component is configured to normally display the contact name information of the contact. In this way, a user can find out a contact directly through the corresponding contact name information normally displayed, different from an existing encryption mechanism in which a user needs to login a verification password or passcode first every time acquiring the contact name information; the device is more convenient for a user to use and improves the satisfaction degree of user experience while ensuring encryption safety. Of course, please referring to FIG. 6, the device for protecting the address book provided in this embodiment may further include a login verification component and a key generation component, wherein the login verification component is configured to perform encryption/decryption login setting before encrypting the contact in the address book, and specifically may store a decryption login verification code required during decryption after encryption, wherein the decryption login verification code is set by a user so as to verify the identity of the user; the key generation component is configured to generate an encryption key and/or decryption key for following encryption and decryption.

In this embodiment, specific encryption/decryption mechanism and algorithms employed by the key generation component may be selected as actually requirement; for example, a symmetric encryption mechanism may be employed to obtain an encryption key and a decryption key which are the same; an asymmetric encryption mechanism may be employed to obtain an encryption key and a decryption key which are different. The random generation algorithm for key is closely correlated to the selected encryption algorithm, for example, when a symmetric encryption algorithm DES is employed, the obtained key is a 64-bit pseudorandom sequence; an algorithm may be selected to randomly generate a 64-bit enhanced key to encrypt contact numbers, and no further description is needed here.

In this embodiment, in order to further enhance the security of encryption, when generating an encryption key and/or decryption key, the encryption key and/or decryption key may be bound with the communication terminal and/or the SIM card in the communication terminal, that is to say, the encryption key and/or decryption key may be generated based on the unique identification code of the communication terminal and/or the unique identification code of the SIM card in the communication terminal (for example, the IMEI of the communication terminal, the IMSI of the SIM card). In this way, when the communication terminal is lost, since the encrypted contact number information in the lost communication terminal has subjected to encryption processing, the contact number information cannot be queried without a correct verification login password; moreover, after the lost SIM card is reported of loss and replaced, the SIM card in the lost communication terminal cannot be used for call and short message connection, which further achieves the privacy of address book.

The device for protecting the address book provided in this embodiment further includes a communication judgement component, a decryption component and a second encryption component, wherein the communication judgement component is configured to: when judging that a current contact performing communication with the communication terminal is an encrypted contact, notify the second encryption component to perform encryption processing, in a communication display interface and/or a communication record of the communication, on contact number information of the current contact. The judging process is that:

when the communication terminal serving as a called party receives a communication request initiated by a calling party, the communication terminal performs decryption processing on all encrypted contact number information in the address book to judge whether the number information of the calling party is in the encrypted contact number information;

when the communication terminal serving as a calling party initiates communication with a contact in the address book, the communication terminal judges whether the contact number information corresponding to the contact name information of the contact is encrypted. For the specific process of the above judging process, please refer to the relevant description in Embodiment 1, and no further description is needed here.

The device for protecting the address book provided in this embodiment may further include a communication initiation component, a communication processing component and a decryption component, wherein the communication initiation component is configured to initiate a communication request to a contact in the address book; when a communication judgment component finds the contact through the name information of the contact and determines that the contact number information of the contact is encrypted, the communication judgment component notifies the decryption component to perform decryption processing on the contact number information of the contact and notifies the second encryption component that the current contact performing communication with the communication terminal is an encrypted contact; the communication processing component is configured to acquire the contact number information of the contact to implement communication after the decryption component decrypts the contact number information; the second encryption component performs, in the communication display interface and/or communication record, encryption processing or encryption tag processing on the contact number information of the contact. When the record or the address book is viewed, merely the contact name information of the contact can be viewed, the contact number information cannot be viewed; the presented interface may display merely the contact name, not display the communication number.

The device for protecting the address book provided in this embodiment may further include a communication receiving component, a second communication processing component and a decryption component, wherein the decryption component is configured to perform decryption processing on the encrypted contact number information in the address book at the request of the communication judgment component when the communication receiving component receives a communication request; the communication judgement component judges whether the contact number information of the contact initiating the communication request is encrypted contact number information after the decryption component decrypts the contact number information; when a judgment result is that the contact number information of the contact initiating the communication request is the encrypted contact number information, the second encryption component performs, in the communication display interface and/or the communication record, encryption processing or encryption tag processing on the contact number information of the contact. When the record or the address book is viewed, merely the contact name information of the contact can be viewed, the contact number information cannot be viewed; the presented interface may display merely the contact name, not display the communication number.

The device for protecting the address book provided in this embodiment further includes an information viewing component and a login verification component, wherein the information viewing component is configured to send to the login verification component a request for viewing contact number information of an encrypted contact in the address book according to an instruction of a user; the login verification component is configured to judge whether the decryption login verification code input by the user initiating the request is the same as the stored decryption login verification code, and, when a judgment result is that the decryption login verification code input by the user initiating the request is the same as the stored decryption login verification code, notify the decryption component to perform decryption processing on the contact number information of the contact so as to present the contact number information to the user.

It should be understood that the first encryption component and the second encryption component in this embodiment may be one encryption component, or may be several encryption components existing independently; each encryption component may employ the same encryption mechanism and algorithm, or employ different encryption mechanisms and algorithms.

It should be understood that the ordinary skilled in the art may understand that all or part steps in the above method and each of the above function components may be implemented by instructing related hardware through a program; the program may be stored in a computer readable storage medium, for example Read-Only Memory (ROM), disc or compact disc. Optionally, all or part steps in the above embodiments may also be implemented by one or more integrated circuits. Correspondingly, each component/element in the above embodiment may be realized in the form of hardware, or in the form of software function modules. The present disclosure is not limited to any combination of specific hardware and software. For this, please referring to FIG. 7, the embodiment further provides a communication terminal, which may be a mobile phone terminal, an IPAD and other mobile communication terminals, also may be other non-mobile communication terminals with an address book, including a memory and a processor, wherein the memory is configured to store at least one program module and the processor is configured to call at least one of the program components to execute the following steps of:

Encryption processing is performed on contact number information of at least one contact in an address book, such that, after encryption, the contact number information of the contact is hidden, and contact name information of the contact is displayed normally. The user is not required to perform a login verification operation, except for the operation of viewing an encrypted contact, thus improving the user experience.

Of course, in this embodiment, before encrypting the contact in the address book, a step of performing encryption/decryption login setting is firstly executed. In the step, a decryption login verification code required during decryption after the encryption is set by the user, so as to verify the identity of the user; in this step, an encryption key and/or decryption key may also be generated for following encryption and decryption.

After the contact number of a corresponding contact is encrypted through the above encryption steps, the current operation refers to initiating a communication request, for example, a communication operation such as short message communication and call communication is initiated to a contact in the address book. The contact is found through the name information of the contact and whether the contact number information corresponding to the contact name information has been encrypted is judged; when the contact number information corresponding to the contact name information has been encrypted, the contact number information of the contact is automatically decrypted to obtain the contact number information of the contact so as to implement communication, and then the contact number information of the contact is shielded in the communication display interface (for example, a call interface, an information display interface) and/or a communication record (for example, a call record, a short message record) of this communication; specifically, the shield operation may be realized through encrypting processing or encryption tags processing. When the record or the address book is viewed, merely the contact name information of the contact can be viewed, the contact number information cannot be viewed; the presented interface may display merely the contact name, not display the communication number. The communication process includes the following steps:

whether the current communication object is an encrypted contact is judged; when the current communication object is the encrypted contact, the contact number information is obtained to implement corresponding communication, after performing decryption processing on the contact number information of the contact using the decryption key generated previously; encryption processing or encryption tag processing is performed, in the communication display interface (for example, a call interface, an information display interface) and/or a communication record (for example, a call record, a short message cord), on the contact number information of the contact. When the record or the address book is viewed, merely the contact name information of the contact can be viewed, the contact number information cannot be viewed; the presented interface may display merely the contact name, not display the communication number; otherwise, normal communication processing is performed, including normally implementing communication and storing communication records, etc.

When the communication terminal serves as a called terminal, when receiving a communication request, the process includes the following steps:

when receiving a communication request, decryption processing is performed on an encrypted contact number information in the address book; whether contact number information of the contact initiating a communication request is encrypted contact number information is judged; when the contact number information of the contact initiating the communication request is the encrypted contact number information, encryption processing or encryption tag processing is performed on the contact number information of the contact in a communication display interface and/or a communication record of this communication, wherein when the record or the address book is viewed, merely the contact name information of the contact can be viewed, the contact number information cannot be viewed; the presented interface may display merely the contact name, not display the communication number; otherwise, normal communication processing is performed, including normally implementing communication and storing communication records, etc.

When a user is required to view contact numbers, the process may include:

whether the contact to be viewed is an encrypted contact is judged; when a judgment result is that the contact to be viewed is the encrypted contact, decryption login verification is performed; when the verification is passed, decryption processing is performed on the contact number information, and the decrypted contact number information is available for viewing by the user; otherwise, the corresponding contact number information is directly called.

Thus, in the method for protecting the address book provided by this embodiment, a login verification operation is not required to be performed, except for the operation of viewing an encrypted contact, thereby improving user experience. Meanwhile, when the communication terminal of a user is lost or stolen, after the SIM card is reported of loss and replaced, the lost SIM card cannot be used any more; further, since an encryption algorithm is selected and there is a binding operation in the encryption process, and different mobile phones adopt different encryption/decryption keys, the mobile phone employing the same encryption algorithm is incapable of decrypting correctly after the card is changed, thus the encrypted contact information in the SIM card and the mobile phone address book is protected.

The above embodiments are simply to illustrate but to limit the technical scheme of the present disclosure; the present disclosure is described in detail merely by reference to example embodiments. The ordinary skilled in the art should understand that medications or equivalent substitutions may be made to the present disclosure without departing from the spirit and scope of technical scheme of the present disclosure, and these modifications or equivalent substitutions are intended to be covered in the scope of the claims appended below.

### INDUSTRIAL APPLICABILITY

The above technical scheme provided by the present disclosure may be applied to protect an address book, including: when encrypting at least one contact in an address book, encryption processing is performed on the contact number information of the contact and no encryption processing is performed on the contact name information of the contact, such that, after encryption, the contact number information of the contact is hidden and the contact name information of the contact can be displayed normally. In this way, a user can find out a contact directly through the corresponding contact name information normally displayed, different from the existing encryption mechanism in which a user is required to login a verification password or passcode first every time acquiring the contact name information; the present disclosure is more convenient for a user to use and improves the satisfaction degree of user experience while ensuring encryption safety.

1. A method for protecting an address book, wherein a contact stored in the address book of a communication terminal at least comprises contact number information and contact name information, the method comprising:
the communication terminal performing encryption processing on contact number information of at least one contact in the address book and displaying contact name information of the contact.

2. The method for protecting the address book as claimed in claim 1, further comprising:
when the communication terminal judges that a current contact performing communication with the communication terminal is an encrypted contact, the communication terminal performing encryption processing, in a communication display interface and/or a communication record of the communication, on contact number information of the current contact.

3. The method for protecting the address book as claimed in claim 2, wherein the communication terminal judging whether the current contact performing the communication with the communication terminal is the encrypted contact comprises:
when the communication terminal serving as a called party receives a communication request initiated by a calling party, the communication terminal performing decryption processing on all encrypted contact number information in the address book to judge whether number information of the calling party is encrypted contact number information;
when the communication terminal serving as a calling party initiates communication with a contact in the address book, the communication terminal judging whether contact number information corresponding to contact name information of the contact is encrypted.

4. The method for protecting the address book as claimed in claim 1, further comprising: the communication terminal storing a decryption login verification code set by a user;
when the communication terminal receives a request for viewing contact number information of an encrypted contact in the address book, the communication terminal judging whether a decryption login verification code input by a user initiating the request is the same as the stored decryption login verification code; when a judgment result is that the decryption login verification code input by the user initiating the request is the same as the stored decryption login verification code, the communication terminal performing decryption processing on the contact number information of the contact.

5. The method for protecting the address book as claimed in claim 1, wherein an encryption key adopted to perform encryption processing on the contact number information is generated based on a unique identification code of a Subscriber Identity Module, SIM, in the communication terminal and/or a unique identification code of the communication terminal.

6. A device for protecting an address book, comprising a first encryption component and a displaying component, wherein the first encryption component is configured to perform encryption processing on contact number information of at least one contact in the address book of a communication terminal, a contact stored in the address book of a communication terminal at least comprises contact number information and contact name information, and the displaying component is configured to display contact name information of the contact.

7. The device for protecting the address book as claimed in claim 6, further comprising a communication judgement component and a second encryption component, wherein
the communication judgement component is configured to: when judging that a current contact performing communication with the communication terminal is an encrypted contact, notify the second encryption component to perform encryption processing, in a communication display interface and/or a communication record of the communication, on contact number information of the current contact.

8. The device for protecting the address book as claimed in claim 6, further comprising a login verification component and a decryption component, wherein the login verification component is configured to: store a decryption login verification code set by a user, and, when receiving a request for viewing contact number information of an encrypted contact in the address book, judge whether a decryption login verification code input by a user initiating the request is the same as the stored decryption login verification code; when a judgment result is that the decryption login verification code input by the user initiating the request is the same as the stored decryption login verification code, notify the decryption component to perform decryption processing on the contact number information of the contact.

9. The device for protecting the address book as claimed in claim 6, further comprising a private key generation component, configured to generate, based on a unique identification code of a Subscriber Identity Module, SIM, in the communication terminal and/or a unique identification code of the communication terminal, an encryption key for encrypting the contact number information.

10. A communication terminal, comprising a memory and a processor, wherein the memory is configured to store at least one program component and the processor is configured to call the at least one program component to execute following steps:
performing encryption processing on contact number information of at least one contact in an address book of the communication terminal and displaying contact name information of the contact.

11. The method for protecting the address book as claimed in claim 2, further comprising: the communication terminal storing a decryption login verification code set by a user;
when the communication terminal receives a request for viewing contact number information of an encrypted contact in the address book, the communication terminal judging whether a decryption login verification code input by a user initiating the request is the same as the stored decryption login verification code; when a judgment result is that the decryption login verification code input by the user initiating the request is the same as the stored decryption login verification code, the communication terminal performing decryption processing on the contact number information of the contact.

12. The method for protecting the address book as claimed in claim 3, further comprising: the communication terminal storing a decryption login verification code set by a user;
when the communication terminal receives a request for viewing contact number information of an encrypted contact in the address book, the communication terminal judging whether a decryption login verification code input by a user initiating the request is the same as the stored decryption login verification code; when a judgment result is that the decryption login verification code input by the user initiating the request is the same as the stored decryption login verification code, the communication terminal performing decryption processing on the contact number information of the contact.

13. The method for protecting the address book as claimed in claim 2, wherein an encryption key adopted to perform encryption processing on the contact number information is generated based on a unique identification code of a Subscriber Identity Module, SIM, in the communication terminal and/or a unique identification code of the communication terminal.

14. The method for protecting the address book as claimed in claim 3, wherein an encryption key adopted to perform encryption processing on the contact number information is generated based on a unique identification code of a Subscriber Identity Module, SIM, in the communication terminal and/or a unique identification code of the communication terminal.

15. The device for protecting the address book as claimed in claim 7, further comprising a login verification component and a decryption component, wherein the login verification component is configured to: store a decryption login verification code set by a user, and, when receiving a request for viewing contact number information of an encrypted contact in the address book, judge whether a decryption login verification code input by a user initiating the request is the same as the stored decryption login verification code; when a judgment result is that the decryption login verification code input by the user initiating the request is the same as the stored decryption login verification code, notify the decryption component to perform decryption processing on the contact number information of the contact.

16. The device for protecting the address book as claimed in claim 7, further comprising a private key generation component, configured to generate, based on a unique identification code of a Subscriber Identity Module, SIM, in the communication terminal and/or a unique identification code of the communication terminal, an encryption key for encrypting the contact number information.
